(19) United States
(12) Patent Application Publication
(10) Pub. No.: US 2017/0070090 A1
(43) Pub. Date: Mar. 9, 2017

(54) SMART ELECTRICAL OUTLET

(71) Applicant: Weifield Group Consulting, Denver, CO (US)

(72) Inventor: Cody Miller, Golden, CO (US)

(21) Appl. No.: 15/259,914

(22) Filed: Sep. 8, 2016

Related U.S. Application Data
(60) Provisional application No. 62/215,505, filed on Sep. 8, 2015.
(60) Provisional application No. 62/222,898, filed on Sep. 24, 2015.

(51) Int. Cl. H02J 13/00; H01R 25/00

(52) U.S. Cl. CPC H02J 13/0079; H01R 25/006; H04W 84/12

(57) ABSTRACT

A smart outlet is described that comprises wireless communication equipment for communicating directly with a wireless access point connected to the Internet. The smart outlet can monitor and report electricity consumption through the outlet, switch a switching mechanism on or off in response to a command, and/or switch a switching mechanism on or off based on an operating schedule stored in memory.

### CROSS-REFERENCE TO RELATED APPLICATIONS

The present application claims the benefit of and priority to, under 35 U.S.C. §119(e), U.S. Provisional Patent Application Ser. No. 62/215,505, filed Sep. 8, 2015 and entitled “Smart Electrical Outlet,” and 62/222,898, filed Sep. 24, 2015 and entitled “Smart Electrical Outlet.” The entire disclosures of the foregoing applications are hereby incorporated by reference, in their entirety, for all that they teach and for all purposes.

### FIELD OF THE INVENTION

The present disclosure is generally directed to electrical outlets, and more specifically to electrical outlets that can be wirelessly monitored and controlled.

### BACKGROUND

Electrical outlets have long been well known and are widely used, particularly in buildings (including industrial, commercial, and residential buildings). Electrical outlets may also be found, however, in vehicles, ships, airplanes, and spacecraft, and in outdoor venues such as parks, campgrounds, shelters, and the like. Electrical outlets provide a relatively safe, user-friendly interface that allows energy consumers to selectively and conveniently connect various devices powered by electricity to a power source.

Electrical outlets are often connected to a manually operated switch that allows an energy consumer to turn on or turn off power to any electronic devices that are plugged into the outlet. Power strips, for example, generally constitute a group of electrical sockets connected to an on/off switch, all of which receive power from an additional electrical outlet into which the power strip's electrical cord is plugged. Other electrical outlets are built-in to the structure of a building, and may or may not be connected to a manually operated switch.

### SUMMARY

The development of the Internet and, more recently, the proliferation of mobile devices with Internet access has resulted in various attempts to provide electrical outlets that can be controlled or monitored over the Internet. To date, however, such attempts have resulted in clumsy, expensive systems. These systems require users to purchase a manufacturer-specific hub that connects to the Internet on one hand (e.g. through a router) and to the manufacturer's electrical outlets on the other, using proprietary connections and/or communication protocols that are incompatible with other manufacturer's products and/or standard WiFi signals.

As described herein, a smart outlet can be connected directly to the Internet or some other communication network, for example via WiFi, without needing an intermediary such as a proprietary hub.

A smart outlet according to one embodiment of the present disclosure includes a plurality of electrical contacts for connection to a power source; a processor; a memory storing instructions for execution by the processor; one or more electrical sockets; a switching mechanism electrically connected to at least one of the one or more electrical sockets, the switching mechanism configured to selectively interrupt electrical current flow between the power source and the at least one of the one or more electrical sockets; a current sensor; a wireless communication interface configured to utilize an 802.11 wireless local area network standard to communicate directly with a non-proprietary wireless access point connected to the Internet; and a control button for use in establishing a wireless connection directly between the smart outlet and the wireless access point.

The processor may be configured to actuate the switching mechanism upon receipt of a command via the wireless communication interface. The processor may also be configured to store data from the current sensor in the memory. The smart outlet may include a real-time clock, and the processor may be configured to utilize the real-time clock to actuate the switching mechanism according to a schedule stored in the memory. The processor may further be configured to transmit information from the current sensor via the wireless communication interface.

The switching mechanism may be at least a 15-amp relay or at least a 20-amp relay. The smart outlet may comprise a timer, and the processor may be configured to execute different instructions based upon the length of time for which the control button is pressed. The smart outlet may further include an LED, and the LED may be configured to display a plurality of light patterns, each pattern associated with a different operating condition of the smart outlet. The processor may be configured to encrypt information sent via the wireless communication interface and to decrypt information received via the wireless communication interface.

The smart outlet may have maximum outer dimensions of 2.65 inches high, 1.75 inches wide, and 1.9 inches deep, exclusive of any mounting hardware attached to the smart outlet. Additionally or alternatively, the smart outlet may have a maximum volume of 13 cubic inches, exclusive of any mounting hardware attached to the smart outlet. The smart outlet may include a ground fault circuit interrupter.

According to another embodiment of the present disclosure, a smart outlet may comprise a plurality of electrical contacts for connection to a power source; a processor; a memory storing instructions for execution by the processor; one or more electrical sockets; a switching mechanism electrically connected to at least one of the one or more electrical sockets, the switching mechanism configured to selectively allow electrical current flow between the power source and the at least one of the one or more electrical sockets in an on position and to selectively interrupt electrical current flow between the power source and the at least one of the one or more electrical sockets in an off position; at least one sensor; and a wireless communication interface configured to utilize an 802.11 wireless local area network standard to communicate directly with a wireless access point connected to the Internet. The smart outlet may have maximum outer dimensions of 3 inches high, 2.25 inches wide, and 2.5 inches deep, exclusive of any mounting hardware attached to the smart outlet.

The memory of the smart outlet may store instructions for causing the processor to signal the switching mechanism to switch to one of the on position and the off position in the absence of a wireless connection. The at least one sensor may be a temperature sensor, and the memory may store instructions for execution by the processor that, when executed by the processor, cause the processor to send a message via the wireless communication interface when the temperature sensor detects a temperature greater than a predetermined temperature. Additionally or alternatively, the memory may store instructions for execution by the processor that, when executed by the processor, cause the processor to signal the switching mechanism to switch to the off position in response to information detected by the at least one sensor. The plurality of electrical contacts for connection to a power source may consist of a positive terminal, a negative terminal, and a ground terminal. Also, the smart outlet may further comprise at least one USB port.

In still another embodiment of the present disclosure, a smart outlet may comprise a processor; at least one electrical socket; a relay; a wireless communication interface; a current sensor electrically coupled to the at least one electrical socket; a control button; and a memory storing instructions for execution by the processor. The instructions may be configured to cause the processor to establish a wireless connection with a wireless access point via the wireless communication interface, using an IEEE 802.11 wireless communication protocol, in response to the pressing of the control button; actuate the relay to selectively open or close an electrical connection between a power source and the at least one electrical socket in accordance with at least one of a command received via the wireless communication interface or a schedule stored in the memory; periodically obtain data corresponding to the flow of electrical current through the one or more electrical sockets from the current sensor; and store the data in the memory or transmit the data via the wireless communication interface.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The terms “determine,” “calculate,” and “compute,” and variations thereof, when used herein to describe an operation of a processor, are used interchangeably and include any type of methodology, process, mathematical operation, or technique.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a front view of a smart outlet according to one embodiment of the present disclosure.

FIG. 2 is a block diagram of the smart outlet of FIG. 1.

FIG. 3 is a diagram of one system in which smart outlets according to the present disclosure may be used.

FIG. 4 is a flow diagram of a method according to one embodiment of the present disclosure.

FIG. 5 is a front view of a smart outlet according to another embodiment of the present disclosure.

FIG. 6 is a front view of a smart outlet according to still another embodiment of the present disclosure.

FIG. 7 is a block diagram of a smart light fixture according to yet another embodiment of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Various examples are provided throughout the following disclosure. The disclosure of examples is in all cases intended to be non-limiting, including specifically when examples are identified with the terms or phrases identifying what follows to be an example, including the terms of phrases “for example,” “as one example,” “such as,” “by way of example,” and “e.g.” In other words, the disclosure of one or more examples is not intended to limit the present disclosure to embodiments conforming to the disclosed example(s).

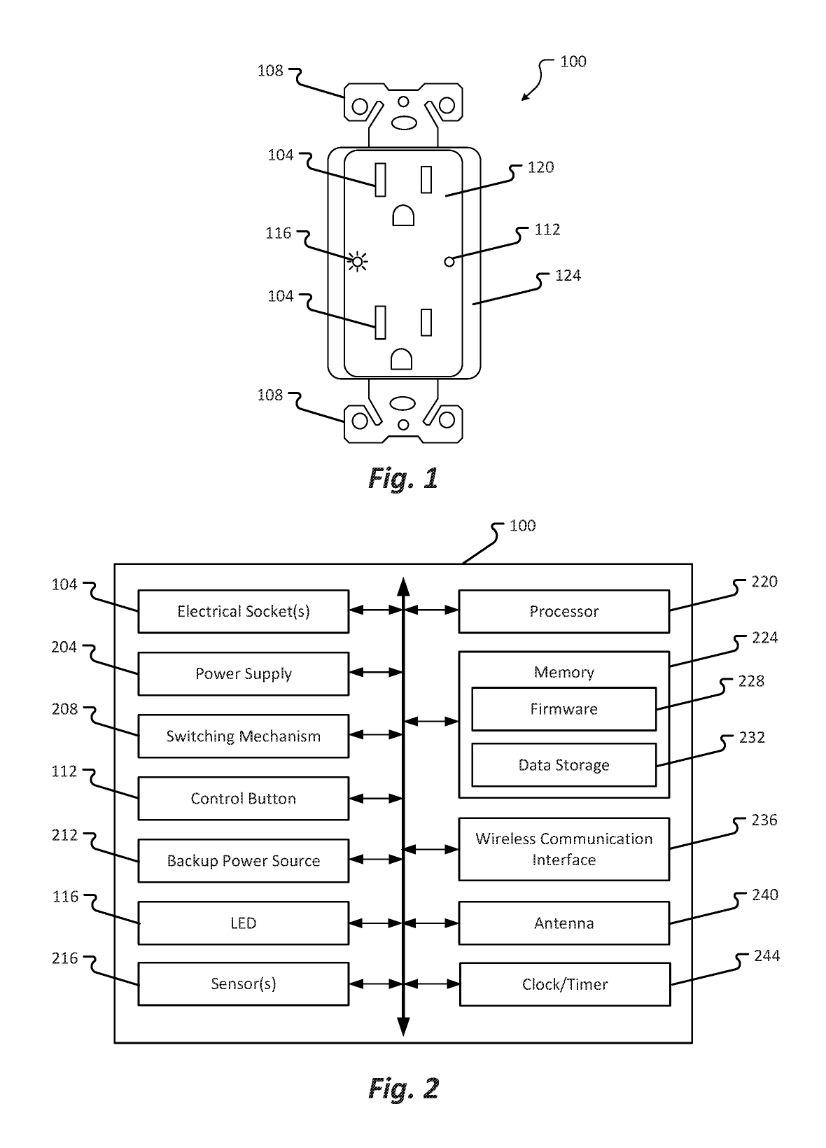

Referring first to FIGS. 1 and 2, a smart outlet 100 according to one embodiment of the present disclosure includes one or more electrical sockets 104 for receiving plugs associated with electronic devices, as well as mounting hardware 108, a control button 112, and an LED light 116. The smart outlet 100 further comprises a faceplate 120 and an electronics box 124, in which additional components of the smart outlet 100 are mounted, including a processor 220, a power supply 204, a wireless communication interface 236, onboard memory 224, and a switching mechanism 208.

Although depicted in FIG. 1 with two Type B electrical sockets, smart outlets according to embodiments of the present disclosure may comprise any type of electrical socket. For example, a smart outlet may have one or more Type A, Type B, Type C, Type D, Type E, Type F, Type G, Type H, Type I, Type J, Type K, Type L, Type M, Type N, or Type O sockets. Additionally, smart outlets of the present disclosure may comprise any number of electrical sockets. While common electrical boxes are sized for outlets having two, four, or even six electrical sockets, smart outlets as disclosed herein may comprise other numbers of electrical sockets, including odd numbers of electrical sockets.

The mounting hardware 108 of the smart outlet 100 comprises metal tabs extending from the top and bottom portions of the faceplate 120 and/or electronics box 124. The metal tabs may comprise the ends of a single metal piece that extends through the smart outlet 100 behind the faceplate 120. Additionally, the metal tabs may be in electrical connectivity with a ground wire of the smart outlet 100.

The mounting hardware 108 includes various holes which may be used to attach the smart outlet 100 to an electrical box or other supporting member (e.g. with screws or other mechanical fasteners), as well as to attach to the mounting hardware 108 a wall plate that surrounds the faceplate 120 of the smart outlet 100 for aesthetic purposes. In some embodiments, smart outlets according to the present disclosure may comprise additional or alternative mounting hardware beyond that shown in FIG. 1, which may extend from the top, bottom, and/or side of the smart outlet and may contain captive mounted screws for ease of installation.

The control button 112 may comprise any button, switch, or other mechanism for selectively closing, opening, or otherwise engaging an electrical circuit and creating, or causing to be created, an electronic signal that is routed to the processor 220. For example, the control button 112 may comprise an elongated plastic cylinder that extends from the faceplate 112 into the electronics box 124 and abuts a wire or other conductive member that is biased away from an electrical contact with, for example, a spring. When the control button 112 is pressed, the elongated plastic cylinder may overcome the biasing force of the spring and press the wire or other conductive member against the electrical contact, thus closing a circuit. Various uses for the control button 112 are discussed in more detail below.

The LED 116 may comprise a stand-alone LED, or it may comprise a light-conducting member that extends from an LED located within the electronics box 124 to the faceplate 120 and allows light from the LED to be visible at the faceplate 124. The LED 116 may be capable of emitting a plurality of colors of light. In some embodiments, the smart outlet 100 may comprise a plurality of LEDs 116. The LEDs 116 may be configured to emit light constantly as well as to flash in different patterns (e.g. low-frequency blinking, high-frequency blinking) and/or colors to convey different messages to a user. For example, an LED 116 that is always on, and/or that is red, may indicate that the smart outlet 100 does not have a wireless connection; an LED 116 that slowly flashes on and off, and/or that is yellow, may indicate that the smart outlet 100 is attempting to establish a wireless connection; and an LED 116 that quickly flashes on and off, and/or is blue, may mean that the smart outlet 100 will switch power from off to on, or from on to off, within a predefined period of time (e.g. ten seconds, thirty seconds, a minute, etc.).

The faceplate 120 protects the various internal components of the smart outlet 100 from damage, prevents users of the smart outlet 100 (or simply persons or animals near the smart outlet 100) from touching one or more components of the smart outlet 100 that might deliver an electric shock, and provides an aesthetic cover for the various inner components of the smart outlet 100. The faceplate 120 may be made out of plastic or other non-conductive material, and may be painted or otherwise colored to match a surrounding wall plate or wall.

The electronics box 124 may also be made out of plastic or other non-conductive material. The electronics box 124 both contains and protects various components of the smart outlet 100, including, for example, the power supply 204, the processor 220, and the memory 224, and also comprises one or more internal mounts to which these and other components may be secured.

The processor 220 executes firmware 228 stored in the memory 224 and controls various components of the smart outlet. The processor 220 may be an application specific integrated circuit (ASIC), a microprocessor, a programmable controller, or the like.

The power supply 204 converts the electricity supplied by the power source to which the outlet is connected (which may be, for example, 120 volt alternating current) to meet the power requirements of the processor 220 and other powered components of the smart outlet 100 (which may, for example, use 5-volt direct current). In some embodiments, a battery (whether rechargeable or not) may be used to power the processor 220 and other powered components of the smart outlet 100.

The wireless communication interface 236 is configured to wirelessly communicate using one or more wireless communication standards employed by wireless routers, such as an IEEE 802.11 wireless local area network (WLAN) standard. In some embodiments, the wireless communication interface 236 may be configured to utilize a Bluetooth or Bluetooth Low Energy (BLE) protocol for wireless communications. The wireless communication interface sends and receives information using an antenna 240.

The memory 224 stores firmware 228 containing instructions for execution by the processor 220. The memory 224 also comprises data storage 232 for storing other information described herein, such as data from one or more sensors 216. As examples, the memory 224 may comprise RAM, DRAM, SDRAM, ROM, EPROM, EEPROM, or other solid state memory.

The switching mechanism 208 may be selected based on the types of devices that will be plugged into the smart outlet 100 and/or based on applicable building codes, and may be, for example, a 10-amp relay or greater, a 15-amp relay or greater, or a 20-amp relay or greater. When the smart outlet 100 is intended to be used with heavy-duty appliances, such as an oven or a dryer, the relay may be greater than a 20-amp relay, such as (but not limited to) a 30-amp relay or a 50-amp relay. The relay may be mechanical or solid state. Other switching mechanisms (e.g. triacs, SCRs, opto-triacs, opto-SCRs, or combinations thereof) may also be used, and may be rated for similar currents (e.g. 10 amps, 15 amps, 20 amps, 30 amps, or 50 amps).

In embodiments, the smart outlet 100 is configured with a switching mechanism 208 that fails to the on position, meaning that if the smart outlet 100 loses its wireless connection, it will continue to provide power to a connected device (or, if the smart outlet 100 is switched off when the wireless connection is lost, it will turn on and begin providing power to the connected device). In alternative embodiments, the smart outlet 100 is configured with a switching mechanism 208 that fails to the off position, such that if the smart outlet 100 loses its wireless connection, it will no longer provide power to a connected device. In yet other embodiments, the smart outlet 100 is configured with a switching mechanism 208 that remains in the current position when the wireless connection is lost, such that if the smart outlet 100 was switched on and providing power to a connected device when the wireless connection is lost, it will continue to do so, but if the smart outlet 100 was switched off and not providing power to a connected device when the wireless connection is lost, it will remain in the off position. In still further embodiments, the smart outlet 100 is configured to follow a schedule (e.g. a schedule set by the user or owner of the smart outlet 100) stored in the memory 224 regardless of whether a wireless connection is present. In some embodiments, a user may select a preferred failure mode (e.g. a preferred action for the switching mechanism 208, as controlled by the processor 220, to take if a wireless connection is lost), which selection may be stored in the memory 224 of the smart outlet 100.

In embodiments, a smart outlet 100 may also include a backup power source 212, such as a battery. The battery may, for example, provide power to one or more of the processor 220, the memory 224, the switching mechanism 208, the LED 116, the sensor(s) 216, the real time clock/timer 244, and/or the wireless communication interface 236 when the primary power source (e.g. the electricity supplied by the power source to which the smart outlet 100 is connected) fails. In some embodiments, the backup power source 212 may be configured to provide just enough power to ensure the switching mechanism 208 is in a predetermined state (e.g. on or off, depending on how the smart outlet 100 is configured to respond to a power failure). In other embodiments, the backup power source 212 may store sufficient energy to power the components of the smart outlet 100 (and, in particular, to maintain information stored in memory) for a period of hours or days.

The smart outlet 100 may further include one or more sensors 216. In embodiments, for example, the smart outlet 100 includes a current sensor for monitoring the flow of current to a connected device. When the smart outlet 100 is provided with a current sensor, the processor 220 of the smart outlet 100 can obtain electricity usage data from the current sensor and transmit the electricity usage data in real-time via the wireless communication interface 236, temporarily store the electricity usage data in the memory 224 (e.g. for periodical transmission to a separate device), or both. The connected device may be any device plugged into the smart outlet 100, including but not limited to a lamp or other light source, a kitchen appliance, an air conditioning unit, a computer, a computer monitor, a television, a printer, a game console, a fan, or a mobile device charger. Using another wireless-enabled device, a user or owner of the smart outlet 100 can access or download real-time and historical electricity usage data from the smart outlet 100, and therefore determine the amount of electricity used by a connected device. This information may be useful for investigating excess energy usage, reducing energy consumption and/or for balancing energy consumption throughout a given time period.

Alternatively or additionally, the smart outlet 100 may include a temperature sensor. The processor 220 may be configured to monitor the temperature sensor and to send a message (e.g. to a user or owner) via the wireless communications interface 236 if the sensed temperature exceeds a predetermined value (which may be indicative, for example, of a short circuit or a fire).

Alternatively or additionally, the smart outlet 100 may include a smoke detector and/or a carbon monoxide detector, and the processor 220 may be configured to send a message (e.g. to a user or owner) via the wireless communications interface 236 if smoke or carbon monoxide is detected. As persons of ordinary skill in the art will realize, other sensors 216 may also or alternatively be included in the smart outlet 100, such as (but not limited to) a motion sensor (e.g. for switching power to the electrical socket 104 on or off based on detected motion), a light detector (e.g. for switching power to the electrical socket 104 on or off based on detected light), an accelerometer (e.g. for switching power to the electrical socket 104 off in the event of an earthquake), and/or a moisture sensor (e.g. for switching power to the electrical socket 104 off in the event of a flood).

Also included in the smart outlet 100 is a real-time clock and/or timer 244. The clock/timer 244 may be used to enable time-based control of the smart outlet 100, and more particularly of the electrical socket(s) 104. For example, a user may program the smart outlet 100 to operate the switching mechanism 208 to provide power to the electrical socket(s) 104 during a certain time period (e.g. 8:00 am to 5:00 p.m.), or for a predetermined period of time (e.g. 30 minutes). In some embodiments, the user may program the smart outlet 100 to operate the switching mechanism 208 to provide power to the electrical socket(s) 104 based on information that may be obtained via the wireless communication interface 236, whether from the Internet or another source. Such information may include, for example, weather information (including temperature information and/or precipitation information), lighting information (e.g. the time of sunrise, the time of sunset), or emergency information (e.g. severe thunderstorm warnings, earthquake warnings, flash flood warnings). The clock/timer 244 may be configured to periodically self-update based on data received via the wireless communication interface 236 (e.g. from a network-connected atomic clock). The clock/timer 244 may also be configurable by a user.

The smart outlet 100 is configured for installation in a wall (e.g. in an electrical box, junction box, or similar container) or other structure, where it may be hard-wired to a power source. In such embodiments, the smart outlet may comprise exposed electrical terminals for connecting wiring from the power source (which may be, for example, a building power circuit that receives power from a public utilities power grid, a solar panel array, a building back-up power system, or a generator). In still other embodiments, smart outlets according to embodiments of the present disclosure may not be configured to be hard-wired into a wall or other structure, but may instead be in the form of a power strip that may be selectively connected to an existing, non-smart outlet through a plug.

In some embodiments, the smart outlet 100 may be small enough and sized to fit into standard electrical boxes. As persons of ordinary skill in the art will recognize, the size of a standard electrical box may vary from location to location based upon locally applicable requirements. Accordingly, the smart outlet may be sized differently depending upon the standard size of electrical boxes in a particular location. Additionally, different electrical box size requirements may apply to different types of construction (e.g. residential, commercial, etc.), and therefore the smart outlet may be sized differently for different types of construction. In some embodiments, the smart outlet 100 (excluding mounting hardware 108) may have maximum outer dimensions of 3 inches high, 2.25 inches wide, and 2.5 inches deep. In some embodiments, the smart outlet 100 (excluding mounting hardware 108) may have maximum outer dimensions of 2.75 inches high, 2.0 inches wide, and 2.2 inches deep. In still other embodiments, the smart outlet 100 (excluding mounting hardware 108) may have maximum outer dimensions of 2.65 inches high, 1.75 inches wide, and 1.9 inches deep. In some embodiments, the smart outlet 100 (excluding mounting hardware 108) may have a total volume of less than or equal to 17 cubic inches. In still other embodiments, the smart outlet 100 (excluding mounting hardware 108) may have a total volume of less than or equal to 13 cubic inches. In yet other embodiments, the smart outlet 100 (excluding mounting hardware 108) may have a total volume of less than or equal to 9 cubic inches.

Certain embodiments of smart outlets according to the present disclosure are installed in the same manner, and with the same wiring, as electrical outlets known in the art. Thus, such smart outlets may include a positive terminal, a negative terminal, and (in some embodiments) a ground terminal, to which are connected positive, negative, and (in applicable embodiments) ground wires, respectively. No extra external wiring (e.g. for transferring electricity or electrical signals into or out of the smart outlet) is needed. Other embodiments of smart outlets according to the present disclosure, as noted above, may be configured as stand-alone units (e.g. power strips) that are not intended to be hard-wired into a wall or other location, but rather can be plugged into an existing electrical outlet. In these stand-alone embodiments as well, no wiring is needed to transfer electricity or electrical signals into or out of the smart outlet other than the plug that provides a connection to a primary power source.

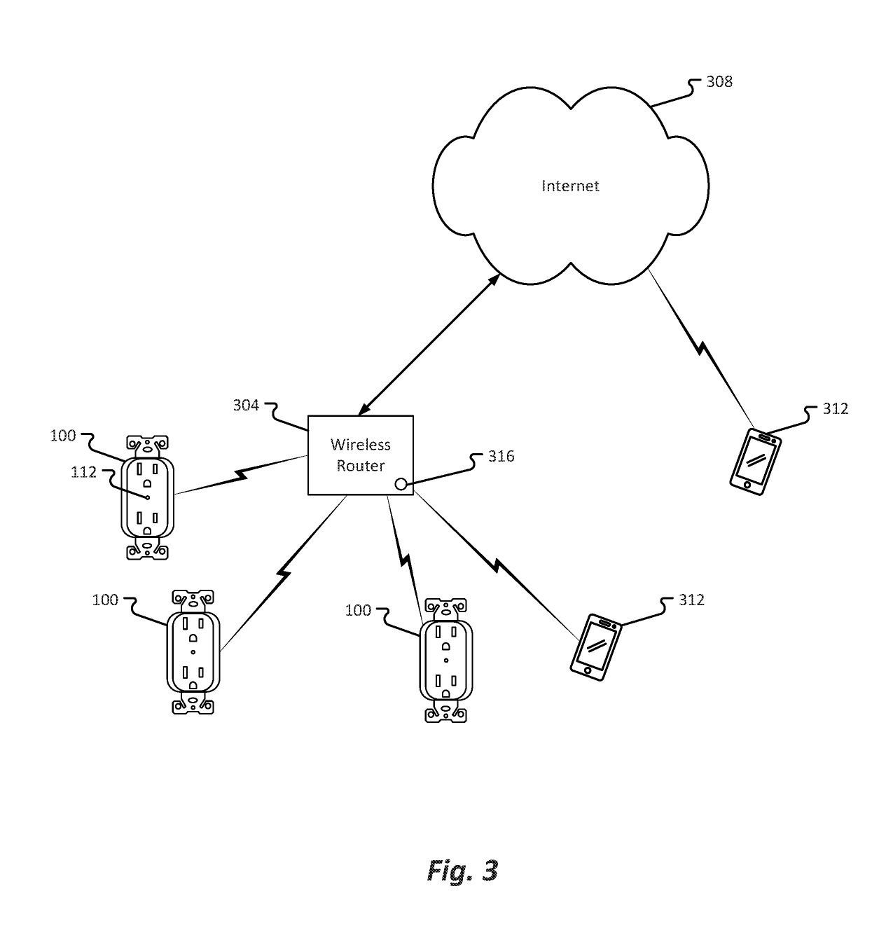

Referring now to FIG. 3, in some embodiments, once a smart outlet 100 according to the present disclosure has been connected to a power source, such that the processor 220, wireless communication interface 236, and other components thereof have power, the smart outlet can be connected to a local wireless network hosted by a wireless router 304. In embodiments of the smart outlet 100 having a battery or other backup power source 212 for providing backup power to certain components of the smart outlet 100, the smart outlet 100 can be connected to a local wireless network hosted by a wireless router 304 even before it is connected to a primary power source (e.g. before the smart outlet 100 is hard-wired to a primary power source or plugged into a primary power source). The wireless communication interface 236 is configured to utilize one or more common wireless networking protocols (e.g. IEEE 802.11) so that no additional equipment (e.g. a proprietary hub) is needed to connect the smart outlet 100 to a wireless local area network.

Many wireless routers include technology for facilitating the establishment of wireless connections with third party devices. For example, Broadcom's SecureEasySetup™ technology allows a user to press a button on a wireless access point, then to press a button on the device to be connected to the wireless access point, after which the wireless connection is automatically set up without further user involvement. As another example, the Wi-Fi Protected Setup™ standard, created by the Wi-Fi Alliance, supports a push-button usage mode where a wireless connection is automatically established when the user pushes a button (real or virtual) on the wireless access point and on the new wireless client device. Such technology may be used in conjunction with the present disclosure. In some embodiments of the present disclosure, for example, a user may press a button 316 on the wireless router 304, after which the control button 112 on the smart outlet 100 may be pushed (typically within a predetermined time period) to connect the smart outlet 100 to the wireless network hosted by the wireless router 304.

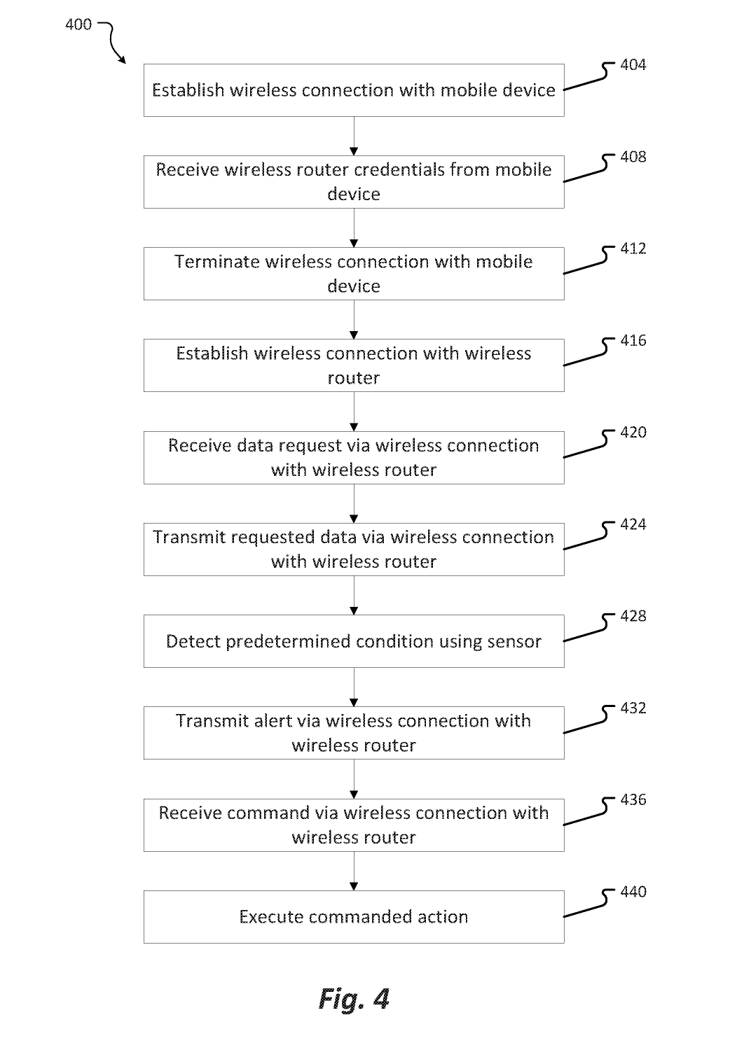

As another example, and with reference now to the method 400 in FIG. 4, a smart phone 312 running a smart phone app may be used to establish a temporary wireless connection between the smart outlet 100 and the smart phone 312 (e.g. using the wireless communication interface of the smart phone 312) (step 404). The smart phone app can then cause the smart phone 312 to transmit to the smart outlet 100, via the temporary wireless connection, the credentials needed by the smart outlet 100 to connect directly to the local wireless router 304 (step 408). Once the smart outlet 100 has the transmitted credentials, the temporary wireless connection between the smart outlet 100 and the smart phone 312 is disconnected (step 412), and the smart outlet 100 establishes a wireless connection directly with the local wireless router 304 (step 416). These or other technologies, whether currently known or yet to be developed, may be used to establish a direct wireless connection between the smart outlet 100 and the wireless router 304 or other wireless access point.

After a wireless connection between the smart outlet 100 and the wireless router or access point 304 has been established, information from one or more sensors 216 or other components of the smart outlet 100 can be accessed by sending a request from the smart phone 312 to the smart outlet 100 via the wireless router 304 (step 420). For example, a user may be able to wirelessly access information from the smart outlet 100 about current flow through the smart outlet 100 (as measured by a current sensor); information about power consumption of a device plugged into an electrical socket 104 of the smart outlet 100 (as derived from current flow information measured by a current sensor); information about the temperature of the smart outlet 100 (as measured by a temperature sensor); or information about any other data gathered by a sensor 216 in the smart outlet 100. The processor 220, upon receiving a request for data from one or more sensors 216 (which data may or may not already be stored in the data storage 232 of the memory 224), or a request for other information from the smart outlet 100, transmits the requested data (if available) to the requestor via the wireless router 304 (step 424).

Additionally, one or more sensors 216 of the smart outlet 100 may detect a condition that satisfies a predetermined requirement (step 428). The wireless connection between the smart outlet 100 and the wireless router 304 may then be utilized to transmit an alert from the smart outlet 100 to a device (e.g. a smart phone 312) of the user or owner of the smart outlet 100 (step 432). For example, if the smart outlet 100 comprises a temperature sensor, and the temperature sensor detects a temperature that exceeds a predetermined temperature, then the processor 220 may generate an alert and cause the alert to be sent via the wireless communications interface 236 to the wireless router 304 and on to the smart phone 312 or other device of the user or owner of the smart outlet 100. Alternatively, if the smart outlet 100 comprises a smoke or carbon monoxide detector, which detects smoke or carbon monoxide, respectively, then the processor 220 may generate an alert and cause the alert to be sent via the wireless communications interface 236 to the wireless router 304 and on to the smart phone 312 or other device of the user or owner of the smart outlet 100.

The wireless connection between the smart outlet 100 and the wireless router 304 may further be advantageously utilized by a user or owner of the smart outlet 100, who may send one or more commands to the smart outlet 100 (e.g. via a smart phone 312) (step 436). Upon receipt of each command, the processor 220 executes the commanded action (step 440). For example, a user or owner of a smart outlet 100 having a switching mechanism 208 may send a wireless command (e.g. using a mobile device such as a smart phone 312) to the smart outlet 100 via the wireless router 304 (and, in some instances, via the Internet 308 as well, e.g. if the smart phone 312 is not connected to the same local area network as the smart outlet 100) that causes the processor 220 to actuate the switching mechanism 208 to turn on or turn off the flow of electricity through the electrical socket(s) 104 to a connected device. Thus, if a homeowner is out of the house and needs to turn off a connected device, he or she can send a wireless command to the smart outlet 100 that causes the processor 220 to actuate the switching mechanism 208 to switch to an off position, thus shutting off the flow of electricity to the connected device. Alternatively, if a homeowner will soon be returning home and wants to turn on a connected device (e.g., a lamp or an air conditioner), he or she can send a wireless command to the smart outlet 100 that causes the processor 220 to actuate the switching mechanism 208 to switch to an on position, thus restoring the flow of electricity to the connected device.

Additionally, the user of a smart outlet 100 may program the smart outlet 100 to turn on and off according to a particular schedule, using the clock/timer 244. The user may, for example, program the smart outlet 100 to turn off every weekday at 8:00 a.m. and to turn on every weekday at 5:00 p.m., so that a connected device is not powered on while the user is at work. As another example, if the smart outlet 100 is installed in a place of business, the smart outlet 100 may be programmed to remain in the on position during business hours, and to switch to the off position when the business is closed. The schedule may be stored in the memory 224 of the smart outlet 100, so that if the wireless connection is interrupted, the smart outlet 100 still has access to and follows the schedule. The schedule may be created, for example, using a computer or mobile device (e.g. a smart phone 312) with Internet access, then once complete may be uploaded to the memory 224 of the smart outlet 100. The processor 220 in the smart outlet 100 may then actuate the switching mechanism 208 at the appropriate times according to the schedule.

In some embodiments according to the present disclosure, a smart outlet 100 includes any number of electrical sockets 104, each allowing one device to be connected to the smart outlet 100. According to some embodiments of the present disclosure, each socket 104 in the smart outlet 100 is monitored and/or controlled independently. In these embodiments, for example, a user may be able to view the electricity usage, whether historical or in real-time, for each socket 104. The user may also be able to turn each socket 104 on or off independently, and/or to set a different schedule for each socket 104. In other embodiments, the sockets 104 on a smart outlet 100 are monitored and/or controlled as a group, such that only the total electricity usage of the smart outlet 100 (whether historical usage or real-time usage) may be viewed by the user, and/or such that all of the sockets 104 are switched on or off as a group, and/or such that a single schedule controls all of the sockets 104 in the smart outlet 100. In still further embodiments, a user can define groups of one or more sockets 104, and each group can be monitored and/or controlled independently of any other group.

The present disclosure also encompasses the use of a plurality of smart outlets 100. In a home or business where multiple smart outlets 100 are installed, for example, the smart outlets 100 may be capable of communicating with each other via their respective wireless connections to a wireless access point, such as the router 304. This allows for more advanced programming of the smart outlets 100. For example, in some embodiments, the smart outlets 100 may be programmed to ensure that electricity consumption through the smart outlets never exceeds a maximum total value. In these embodiments, the smart outlets 100 communicate their real-time electricity usage information to each other, and switch on or off as necessary to keep total real-time electricity usage below the maximum amount. In other embodiments, multiple smart outlets may be controlled by a single on or off command, or multiple smart outlets may follow the same schedule.

According to some embodiments of the present disclosure, a software program running on a desktop or laptop computer, or an app running on a mobile device (such as a smart phone 312), is used to view information from a sensor 216 or other component of a smart outlet 100 (e.g. from the clock/timer 244), to send commands to the smart outlet 100, and/or to provide a schedule to the smart outlet 100. The program or app may communicate directly with the smart outlet 100 via the wireless connection. In other embodiments, a cloud-based service accessible through the Internet 308 may serve as an intermediary between a user and a smart outlet 100. The cloud-based service may have, for example, a web portal through which information from a particular smart outlet 100 may be accessed, and/or through which settings for a smart outlet 100 may be configured, and/or through which commands can be sent to the smart outlet 100, and/or through which a schedule can be created for the smart outlet 100. The program, app, or cloud-based service may provide a grouping functionality that allows a user to view total electricity usage across multiple smart outlets 100, and/or that allows a user to issue a single command to a plurality of smart outlets 100, and/or that allows a user to set a single schedule for a plurality of smart outlets 100. When the program, app, or cloud-based service is used to control multiple smart outlets 100, the smart outlets 100 need not be configured to communicate with each other; rather, the program, app, or cloud-based service can obtain electricity usage information from, or provide a command or a schedule to, each smart outlet 100 individually, based on a single request, command, or schedule from a user.

Additionally, the program, app, or cloud-based service may be configured to occasionally or periodically receive or retrieve historical electricity usage information from the smart outlet 100. As persons of ordinary skill in the art will recognize, the more frequently historical electricity usage information is retrieved from the smart outlet 100, the less space in the memory 224 is needed to store such information, which can be deleted once retrieved. Even if historical electricity usage information is periodically or occasionally uploaded from the smart outlet 100 to another device, one or more circumstances (e.g. loss of wireless connection) may occur that result in the memory 224 reaching its capacity. In anticipation of such occurrences, the firmware 228 may be configured to cause the processor 220 to begin overwriting the oldest electricity usage data as new data is collected once the memory 224 is full, or to delete all presently stored electricity usage data to create room for new data. Alternatively, the firmware 228 may be configured to cause the processor 220 to calculate average electricity usage amounts per a given time period (e.g. minute, hour, day, etc.) based on the stored data, and then to save the calculated averages but delete the stored data from which the averages were calculated so as to create more available space for new electricity usage data. As yet another alternative, the firmware 228 may be configured to cause the processor 220 to recognize that the memory 224 will reach maximum capacity within a given period of time, and in response to begin saving only average electricity usage data, or only a snapshot of electricity usage data (e.g. the amount of electricity being used at the top of each hour), so as to reduce the amount of data being stored in the memory 224 and thus to delay the reaching of maximum memory capacity. In embodiments, a user may select any one of these options for dealing with the reaching of maximum memory capacity, which setting may then be stored in memory 224.

According to some embodiments of the present disclosure, the smart outlet 100 is configured to support the IFTTT protocol. Support for the IFTTT protocol may be included in the firmware stored in the memory 224 of the smart outlet 100, or it may be provided by the software, app, or cloud-based service used to access information from and control the smart outlet 100.

As persons of ordinary skill in the art will recognize, the ability of a smart outlet 100 to connect to a wireless access point (e.g. the wireless router 304) means that the smart outlet 100 can be accessed (e.g. to obtain electricity usage data, to provide commands, or to set or update an operating schedule) by a user regardless of the user's location, as long as the user has an Internet connection (and as long as the local network to which the smart outlet is connected is also connected to the Internet). As a result, a user may control his or her smart outlet(s) 100 from around the world, for example using a smart phone 312 connected to the Internet 308. To prevent unauthorized access to the smart outlet 100 by third parties, communications with the smart outlet 100 may be encrypted and/or protected with an authorization process. Various methods and standards for encrypting wireless communications are well-known, and persons of skill in the art will recognize that any suitable encryption standard may be used in conjunction with smart outlets 100 of the present disclosure.

In some embodiments, smart outlets 100 are equipped with additional features. For example, in some embodiments the control button 112 on a smart outlet 100 may be used not just to set up a wireless connection to a wireless access point (e.g. a wireless router 304), but also to reset the smart outlet 100 (which may be desirable if, for example, control of the smart outlet 100 needs to be transferred from a previous owner to a new owner, or if a new wireless router is installed that requires different credentials for connecting thereto, or if the required credentials for an existing wireless router are changed). Resetting the smart outlet 100 may cause the smart outlet 100 to clear all data (including, for example, electricity usage data, operating schedules, wireless access point credentials) from the memory 224 thereof except for that data included on the memory 224 upon manufacture. The smart outlet 100 may also be programmed to recognize different commands from the control button 112 based on the pattern/sequence in which the button 112 is pushed. For example, a smart outlet 100 may be configured to establish a new wireless connection if the control button 112 is simply pressed and released; to switch from on to off or from off to on if the control button 112 is pressed for an extended period of time, e.g. for three seconds; and to reset the smart outlet 100 if the control button 112 is pressed for an even longer period of time, e.g. for five seconds. The processor 220 may utilize the clock/timer 244 may be used to determine the length of time for which the control button 112 is pressed.

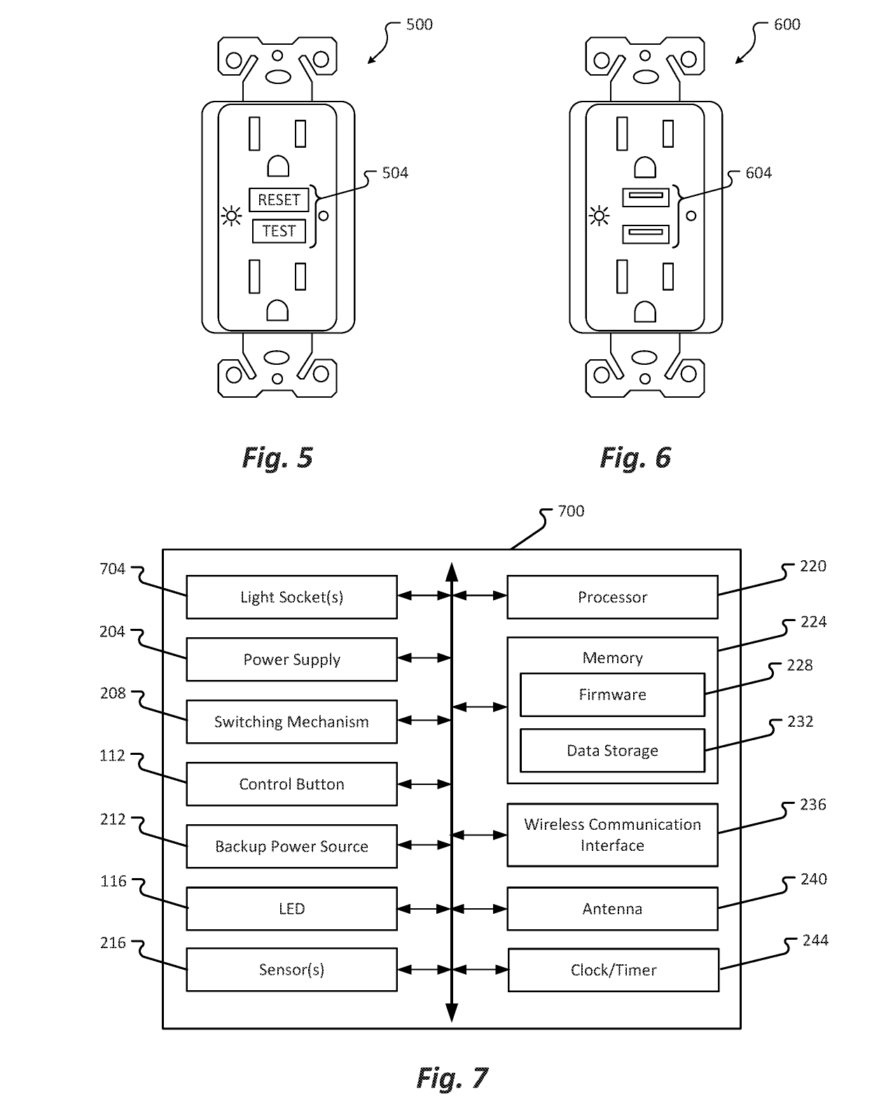

Referring now to FIG. 5, a smart outlet 500 according to some embodiments of the present disclosure may comprise some or all of the components of the smart outlet 100, as well as a ground fault circuit interrupter 504 for installations in which additional safety is needed (e.g. in kitchens and bathrooms). Additionally, with reference to FIG. 6, a smart outlet 600 (again with some or all of the components of the smart outlet 100) may also include one or more USB ports 604. The USB port(s) 604 may be configured to allow charging of devices through the smart outlet 600 over a USB cable connected to the USB port(s) 604. Additionally or alternatively, the USB port(s) 604 may be configured to provide a user with wired access to the memory 224 of the smart outlet 600. Such access may be useful for updating the firmware 228 stored in the memory 224, for downloading electricity usage data to a separate device, for uploading an operating schedule to the memory 224, for troubleshooting problems with the smart outlet 600, and/or as another alternative for switching the smart outlet 600 on or off (e.g. in the absence of a wireless connection).

The teachings of the present disclosure may be useful in a variety of applications. For example, in addition to electrical outlets, the principles of the present disclosure may be applied to or used in conjunction with lights to provide wireless control of lights instead of or in addition to traditional light switches. As with embodiments of the smart outlets described herein, wireless control of the lights may include sending commands that cause power to the lights to turn on or off or to dim the lights; sending a command that causes an electrical signal to be generated that results in a change in color of the lights; setting an operating schedule for providing power to the lights; and/or monitoring electricity usage of the lights.

Referring now to FIG. 7, a smart light fixture 700 according to the principles described herein may include the same components as the smart outlets 100 described herein, but with one or more light sockets 704 instead of one or more electrical sockets 104. The memory 224 of the smart light fixture 700 may store, for example, a schedule set by the user or owner of the smart light fixture 700 for automatically switching the light(s) in the smart light fixture 700 on or off, automatically dimming the lights to predetermined levels (e.g. by using the switching mechanism 208 to adjust the power provided to the lights via the light socket(s) 704), and automatically adjusting the color of the lights (e.g. by transmitting a predetermined signal via the light socket(s) 704, or by switching off power to a light socket powering a light of one color, and switching on power to a light socket powering a light of another color) at different times of day. The smart light fixture 700 may further be configured to communicate with other smart light fixtures 700 (e.g. so that if one smart light fixture 700 is turned on, one or more other smart light fixtures 700 will turn on or off, or so that if one smart light fixture 700 is dimmed or changes color, one or more other smart light fixtures 700 will dim or change color). The smart light fixture 700 may further be configured to flash a certain on-off pattern (or a dimming pattern or a color pattern) prior to executing a prescheduled action (e.g. turning off) as an indication that the prescheduled action is about to happen. A smart light fixture 700 could be controlled using a mobile device or other computer with a wireless connection (e.g. a smart phone 312), and therefore would not require a traditional light switch for control thereof (although a smart light fixture 700 could also be configured to be controlled at least in part by a traditional light switch). Thus, the cost of installing such a traditional light switch, and of wiring the same, could be eliminated.

As can be seen from the above description, the system disclosed herein is useful for monitoring and controlling electricity usage through a smart outlet connected directly to a wireless access point. Specific details were given in the description to provide a thorough understanding of the embodiments. However, it will be understood by one of ordinary skill in the art that the embodiments may be practiced without these specific details. Persons of ordinary skill in the art will also understand that various embodiments described above may be used in combination with each other without departing from the scope of the present disclosure. In this disclosure, well-known circuits, processes, algorithms, structures, hardware, and techniques have been shown and described without unnecessary detail in order to avoid obscuring the embodiments.

What is claimed is:

1. A smart outlet, comprising:
a plurality of electrical contacts for connection to a power source;
a processor;
a memory storing instructions for execution by the processor;
one or more electrical sockets;
a switching mechanism electrically connected to at least one of the one or more electrical sockets, the switching mechanism configured to selectively interrupt electrical current flow between the power source and the at least one of the one or more electrical sockets;
a current sensor;
a wireless communication interface configured to utilize an 802.11 wireless local area network standard to communicate directly with a wireless access point connected to the Internet; and
a control button for use in establishing a wireless connection directly between the smart outlet and the wireless access point.

2. The smart outlet of claim 1, wherein the processor is configured to actuate the switching mechanism upon receipt of a command via the wireless communication interface.

3. The smart outlet of claim 1, wherein the processor is configured to store data from the current sensor in the memory.

4. The smart outlet of claim 1, further comprising a real-time clock, wherein the processor is configured to actuate the switching mechanism according to a schedule stored in the memory.

5. The smart outlet of claim 1, wherein the processor is configured to transmit information from the current sensor via the wireless communication interface.

6. The smart outlet of claim 1, wherein the switching mechanism is at least a 20-amp relay.

7. The smart outlet of claim 1, wherein the switching mechanism is at least a 15-amp relay.

8. The smart outlet of claim 1, further comprising a timer, wherein the processor is configured to execute different instructions based upon the length of time for which the control button is pressed.

9. The smart outlet of claim 1, further comprising an LED, and wherein the LED is configured to display a plurality of light patterns, each pattern associated with a different operating condition of the smart outlet.

10. The smart outlet of claim 1, wherein the processor is configured to encrypt information sent via the wireless communication interface and to decrypt information received via the wireless communication interface.

11. The smart outlet of claim 1, wherein the smart outlet has maximum outer dimensions of 2.65 inches high, 1.75 inches wide, and 1.9 inches deep, exclusive of any mounting hardware attached to the smart outlet.

12. The smart outlet of claim 1, wherein the smart outlet has a maximum volume of 13 cubic inches, exclusive of any mounting hardware attached to the smart outlet.

13. The smart outlet of claim 1, further comprising a ground fault circuit interrupter.

14. A smart outlet, comprising:
a plurality of electrical contacts for connection to a power source;
a processor;
a memory storing instructions for execution by the processor;
one or more electrical sockets;
a switching mechanism electrically connected to at least one of the one or more electrical sockets, the switching mechanism configured to selectively allow electrical current flow between the power source and the at least one of the one or more electrical sockets in an on position and to selectively interrupt electrical current flow between the power source and the at least one of the one or more electrical sockets in an off position;
at least one sensor; and
a wireless communication interface configured to utilize an 802.11 wireless local area network standard to communicate directly with a wireless access point connected to the Internet,
wherein the smart outlet has maximum outer dimensions of 3 inches high, 2.25 inches wide, and 2.5 inches deep, exclusive of any mounting hardware attached to the smart outlet.

15. The smart outlet of claim 14, wherein the memory stores instructions for causing the processor to signal the switching mechanism to switch to one of the on position and the off position in the absence of a wireless connection.

16. The smart outlet of claim 14, wherein the at least one sensor is a temperature sensor, and further wherein the memory stores instructions for execution by the processor that, when executed by the processor, cause the processor to send a message via the wireless communication interface when the temperature sensor detects a temperature greater than a predetermined temperature.

17. The smart outlet of claim 14, wherein the memory stores instructions for execution by the processor that, when executed by the processor, cause the processor to signal the switching mechanism to switch to the off position in response to information detected by the at least one sensor.

18. The smart outlet of claim 14, wherein the plurality of electrical contacts for connection to a power source consists of a positive terminal, a negative terminal, and a ground terminal.

19. The smart outlet of claim 14, further comprising at least one USB port.

20. A smart outlet, comprising:
a processor;
at least one electrical socket;
a relay;
a wireless communication interface;
a current sensor electrically coupled to the at least one electrical socket;
a control button;
a memory storing instructions for execution by the processor, the instructions configured to cause the processor to:
establish a wireless connection with a wireless access point via the wireless communication interface, using an IEEE 802.11 wireless communication protocol, in response to the pressing of the control button;
actuate the relay to selectively open or close an electrical connection between a power source and the at least one electrical socket in accordance with at least one of a command received via the wireless communication interface or a schedule stored in the memory;
periodically obtain data corresponding to the flow of electrical current through the one or more electrical sockets from the current sensor; and
store the data in the memory or transmit the data via the wireless communication interface.
